(19) United States
(12) Patent Application Publication
(10) Pub. No.: US 2001/0041018 A1
(43) Pub. Date: Nov. 15, 2001

(54) Image processing method

(76) Inventor: Fumihiro Sonoda, Kanagawa (JP)

Correspondence Address: SUGHRUE, MION, ZINN, MACPEAK & SEAS, PLLC, 2100 PENNSYLVANIA AVENUE, N.W., WASHINGTON, DC, 20037-3213, US

(21) Appl. No.: 09/774,013

(22) Filed: Jan. 31, 2001

(30) Foreign Application Priority Data
Jan. 31, 2000 (JP) 2000-22635

(51) Int. Cl. G06T 5/00; G06K 9/40; H04N 1/409

(52) U.S. Cl. 382/275; 382/266; 358/463

(57) ABSTRACT

The image processing method reads photoelectrically an image on a film and then performs a blemish elimination processing. The method reads a defective image as information related to a defect on the film, reads photoelectrically the image to obtain an actual image, performs preprocessing for the blemish elimination processing on the defective image and performs the blemish elimination processing on a blemish of said actual image, based on the defective image subjected to the preprocessing. The method can effectively perform processing of eliminating a blemish on the actual image in a short period of time by using the defective image having information pertaining to a defect caused by a scratch, dust on the film in a frame to be read.

### BACKGROUND OF THE INVENTION

This invention relates to the field of image processing technology for eliminating blemishes which is capable of efficiently correcting defects in a frame to be read on a film such as blemishes on actual images produced by scratches, dust and the like in a short period of time when images are photoelectrically read to obtain the actual images such as the images on the prints, the display images and like.

Heretofore, the images recorded on photographic films such as negatives and reversals (which are hereunder referred to simply as “films” have been commonly printed on light-sensitive materials (photographic paper) by means of so-called direct exposure in which the film image is projected onto the light-sensitive material to achieve its exposure.

A new technology has recently been introduced and this is a printer that relies upon digital exposure. Briefly, the image recorded on the film is read photoelectrically, converted to digital signals and subjected to various image processing operations to produce image data for recording Purposes; recording light that has been modulated in accordance with the image data is used to scan and expose a light-sensitive material to record a latent image, which is subsequently developed to produce a print. The printer operating on this principle has been commercialized as a digital photoprinter.

In the digital photo printer, the film is subjected to photoelectric reading and then gradation correction and the like are performed by image (signal) processing to determine an exposure condition. Therefore, edition of a print image such as composition of a plurality of images, division of an image and the like, and various kinds of image processing such as color/density adjustment, edge enhancement and the like can be carried out freely whereby a finished print having been freely edited and processed in accordance with an application can be outputted. Further, the image data of the image recorded on the print can be supplied to a computer or stored in a recording medium such as a floppy disk and the like.

Moreover, the print having a better-quality image which is excellent in resolution, color/density reproduction and the like than that which is obtainable by a conventional direct exposure can be outputted.

Having these features, the digital photoprinter is basically composed of the following units: an image reading apparatus (input apparatus) including a scanner that reads the image recorded on the film photoelectrically to produce image data and an image processing apparatus that performs processing (image processing) on the thus produced image data for determining an exposure condition, that is, producing image data for recording; and a printer (an output machine) that scan-exposes a light-sensitive material in accordance with the image data for recording and then subjects the thus scan-exposed light-sensitive material to development to produce the print.

In the scanner, reading light issuing from a light source is allowed to be incident on the film, from which projected light bearing the image recorded on the film is produced and focused by an imaging lens to form a sharp image on an image sensor such as a CCD sensor; the image is then captured by photoelectric conversion and sent to the image processing apparatus as data for the image on the film after being optionally subjected to various image processing steps. On this occasion, the film is transported on a frame basis in the scanner by a carrier mounted on the scanner whereby the image recorded on the film in each frame is read in succession frame by frame.

The image processing apparatus sets an image processing condition for performing color balance adjustment, contrast correction (gradation processing), brightness correction, saturation correction and the like, and optional corrections of transverse chromatic aberration, distortion aberration and color shift, and electronic magnification, and, thereafter, if desired, sharpness processing, dodging processing and the like and performs image processing on the image data in accordance with the thus set condition to produce processed image data for recording (exposure condition) which is then sent to the printer.

In the printer, for example, if it is of a type that relies upon exposure by scanning with an optical beam, the latter is modulated in accordance with the image data sent from the image processing apparatus and deflected in a main scanning direction as the light-sensitive material is transported in an auxiliary scanning direction perpendicular to the main scanning direction whereby a latent image is formed as the result of exposure (printing) of the light-sensitive material with the image-bearing optical beam The latent image is then subjected to development and other processing steps in accordance with the light-sensitive material to produce a print (photograph) reproducing the image recorded on the film.

Now, in the thus obtained print, there is a case where a minute blemish of image is included in the read actual image which has been caused by a defect on the film in the frame such as a scratch, dust and the like. This blemish is generated by the fact that, when the reading light issuing from the light source is allowed to be incident on the film to obtain a projected light carrying the image recorded on the film, for example, a scratch on the film in the frame or an image of dust attached to the film is included in the projected light carrying the image together with the image recorded in the frame of interest and formed into the actual image.

The blemish of the actual image based on such defect on the film such as the scratch, dust and the like causes a problem which decreases a quality of the image To deal with such problem, as a method to compensate for an effect of the defect in recording medium such as film, a compensation method is proposed in U.S. Pat. No. 5,266,805 where infrared light (ray) and visible light (rays) are incident on the film to obtain energy distribution intensities of infrared light and visible light transmitted through the film corresponding to each location of the film whereupon the defect on the film is corrected by using the thus obtained energy distribution intensities of infrared light and visible light in each location. In the invention of the above-described patent, a degree of the defect on the film is judged from the energy distribution intensities of infrared light whereupon a portion having a low degree of blemish is corrected by increasing the energy distribution intensity of the visible light up to a level which offsets the energy distribution intensity of infrared light and the other portion is corrected by using the energy distribution intensity of the visible light by means of a known interpolation method.

It is considered that the blemish on the actual image caused by the scratch, dust or the like on the film can be corrected by the above-described digital photoprinter by making use of the above-described method.

However, blemish elimination processing can not be performed on the actual image until a defective image where the energy distribution intensity of infrared light which judges the degree of the blemish on the actual image so as to determine a correction method is handled as image data and the actual image comprising R (red), G (green) and B (blue) images where the energy distribution intensity of visible light on each pixel position is handled as image data are obtained. Particularly, in a case that the defect on the film is a blemish having a high frequency, that is, a sharp blemish, the area of the blemish is narrow so that processing for specifying the position thereof with a high degree of precision must be performed. However, this processing consumes a relatively long period of time so that it takes a relatively long period of time to complete the blemish elimination processing.

Therefore, in the digital photoprinter where a large quantity of images recorded on the film are read, subjected to image processing and outputted to the printer in a short period of time, a problem is generated that, since the blemish elimination processing requires much time for print outputting because of the time required for specifying the position of the blemish, efficiency of the processing for print outputting is decreased.

### SUMMARY OF THE INVENTION

The present invention has been accomplished under these circumstances and has as an object providing an image processing method of blemish elimination which can effectively perform processing of eliminating a blemish on an actual image in a short period of time by using a defective image having information pertaining to a defect, for example, caused by a scratch, dust or the like, on a film in a frame to be read, when an image of the film is photoelectrically read.

Another object of the present invention is to provide an image processing method by which whole image processing for obtaining output images including reading of images on a film and the blemish elimination processing can be efficiently performed in a short period of time, that is, at a high speed.

In order to attain the object described above, the present invention provides an image processing method for photoelectrically reading an image on a film and then performing a blemish elimination processing, comprising the steps of reading a defective image as information related to a defect on the film, then, reading photoelectrically the image to obtain an actual image, performing preprocessing for the blemish elimination processing on the defective image while reading photoelectrically said image and performing the blemish elimination processing on a blemish of the actual image, based on the defective image subjected to the preprocessing.

Particularly, in a case that the defect on the film is a blemish having a high frequency, that is, a sharp blemish, the area of the blemish is narrow so that the position thereof must be specified with a high degree of precision; therefore, according to the present invention, the preprocessing, for example edge enhancement processing such as sharpness enhancement and the like is preliminarily performed on the defective image. However, the preprocessing consumes a relatively long period of time so that it takes a relatively long period of time to complete the blemish elimination processing.

Therefore, in the digital photoprinter where a large quantity of images recorded on the film are read, subjected to image processing and outputted to the printer in a short period of time, a problem is generated that, since the blemish elimination processing cannot be performed while the above-described edge enhancement processing is being performed, efficiency of the blemish elimination processing is decreased. According to the present invention, the blemish elimination processing on the actual image can be efficiently performed particularly in a short period of time or at a high speed by performing the preprocessing while acquiring the actual image, for example while reading the image on a film photoelectrically.

Preferably, the preprocessing is finished up to completion of obtaining the actual image.

Preferably, the image on the film is sequentially read on a plane basis, and the actual image is obtained and the blemish elimination processing is performed on the actual image by using the defective image subjected to the preprocessing.

Preferably, the defective image is evaluated to obtain a evaluated result, and the preprocessing and the blemish elimination processing are stopped in accordance with the evaluated result.

Preferably, the preprocessing is edge enhancement processing of the defective image or production of flag information which imparts presence or absence of the defect on a pixel unit basis from the defective image.

Preferably, the defective image is photoelectrically read by using infrared light.

In order to attain the object described above, the present invention provides an image processing method for photoelectrically reading an image on a film and then performing a blemish elimination processing, comprising the steps of reading a defective image as information related to a defect on the film, performing preprocessing for the blemish elimination processing on the defective image; and performing the blemish elimination processing on a blemish of an actual image which is obtained by reading photoelectrically the image, based on the defective image subjected to the preprocessing.

When the blemish on the actual image is subjected to the blemish elimination processing according to the present invention, the preprocessing for the blemish elimination processing, for example edge enhancement processing such as sharpness enhancement is preliminarily performed on the defective image, after which the blemish on the actual image is subjected to the blemish elimination processing using the preprocessed defective image. Therefore, the blemish elimination processing itself can be performed with higher efficiency at a higher speed (in a reduced period of time).

Preferably, the preprocessing is edge enhancement processing of the defective image or production of flag information which imparts presence or absence of the defect on a pixel unit basis from the defective image.

Preferably, the defective image is photoelectrically read by using infrared light.

Preferably, the defective image is evaluated to obtain a evaluated result, and the preprocessing and the blemish elimination processing are stopped in accordance with the evaluated result.

Preferably, the preprocessing is finished up to completion of obtaining the actual image.

### BRIEF DESCRIPTION OF THE DRAWINGS

FIG. 1 is a block diagram of an embodiment of a digital photoprinter which implements an image processing method of the present invention; and

FIG. 2 is a block diagram of an embodiment of an image processing apparatus which primarily implements an image processing method of the present invention.

### DETAILED DESCRIPTION OF THE INVENTION

An image processing method for eliminating a blemish according to the present invention is now described in detail with reference to the preferred embodiments shown in the accompanying drawings.

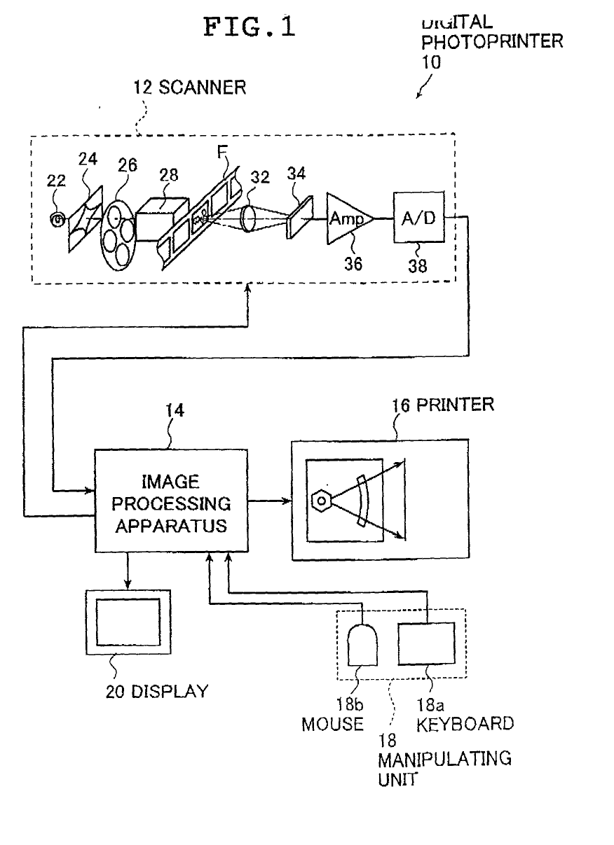

FIG. 1 shows a block diagram of an embodiment of a digital photoprinter which implements an image processing method of the present invention.

The digital photoprinter (hereinafter referred to simply as “photoprinter”) 10 shown in FIG. 1 comprises basically a scanner 12 for photoelectrically reading an image recorded on a film F, an image processing apparatus 14 which performs image processing on image data (image information) read by the scanner 12 to produce image data for recording and a printer 16 which imagewise exposes a light-sensitive material with light beams modulated in accordance with the image data delivered from the image processing apparatus 14 and which performs development and other necessary processing to produce a print. The image processing method according to the present invention is implemented in the scanner 12 and the image processing apparatus 14.

Connected to the image processing apparatus 14 are a manipulating unit 18 having a keyboard 18a and a mouse 18b for inputting (setting) various conditions, selecting and commanding a processing step of such as, as described below, a method of a blemish elimination processing and a display 20 for displaying the image read with the scanner 12, various manipulating commands and screens for setting and registering various conditions.

The scanner 12 is an apparatus with which the image recorded on the film F and the like is read photoelectrically frame by frame. It comprises a light source 22, a variable diaphragm 24 for adjusting a reading light quantity in accordance with the image recorded on the film F, a filter plate 26 which has three color filters or R, C and B color filters for decomposing the image into three primary colors of R (red) G (green) and B (blue) and, further, an infrared filter for producing a defective image as defective information in respect of a scratch and dust on the film F in a frame and also which is capable of applying an arbitrary color filter or infrared filter in a light path by rotation, a diffusion box 28 for allowing the reading light of visible light or infrared light incident on the film F to be uniform in the surface direction of the film F, an image forming lens 32, a CCD sensor 34 as an area sensor for reading the image on the film in one frame, an amplifier 36 and an A/D converter 38.

In the scanner 12 of the photoprinter 10 shown in FIG. 1, dedicated carriers are available that can be loaded into the body of the scanner 12 in accordance with the type or the size of the film used (e.g. whether it is a film of an Advanced Photo System or a negative film of 135 size), the format of the film (e.g. whether it is a strip or a slide), the type of processing (e.g. whether trimming is performed or not) or other factors. By replacing one carrier to another, the photoprinter 10 can be adapted to process various types of films in various modes.

The film F is transported on a frame basis by the carrier whereby each frame (image) is sequentially transported to a predetermined reading position. Accordingly, in the scanner 12, the image of each frame recorded on the film F is sequentially read one by one.

Reading the image in the scanner 12 is performed twice by prescan and fine scan. The prescan which reads the image at a low resolution for determining An image processing condition and the like is first executed in advance of image reading (fine scan) for outputting a print to determine the image processing condition and, after an operator confirms and makes an adjustment on the monitor, fine scan which reads the image at a high resolution is executed.

Further, as characteristics of the present invention, it is arranged that, before the actual image composed of R, G and B images are photoelectrically read by the fine scan via CCD sensor 34, the projected light carrying the defective image on the film F in the frame on which the image of interest was recorded, for example, the image having the scratch, dust, a finger print or dirt, which is obtained by infrared light (infrared ray) that has passed through the infrared filter of the filter plate 26, is allowed to be imaged on a light-receiving plane of the CCD sensor 34; the thus imaged projected light is photoelectrically read by the CCD sensor 34 to produce an output signal; the thus obtained output signal is amplified by the amplifier 36; the thus amplified signal is subjected to A/D conversion and sent to the image processing apparatus 14; thereafter, the actual image composed of R, G and B images captured by the fine scan are photoelectrically read via CCD sensor 34 to produce an output signal; the resultant output signal is amplified by the amplifier 36 and converted by the A/D converter 38 to produce digital image data which is then sent to the image processing apparatus 14.

The infrared light which has passed through the film F carries only the defect such as the scratch, dust and the like on the film F intact and does not carry a picture of the image recorded on the film F. Therefore, in the image photoelectrically read by the CCD sensor 34, the defective image having information related to the defect on the film F in the frame such as the shape, position, degree of the defect, or the like is obtained. This is due to the fact that the infrared light is not absorbed by the picture of the image on the film F, whereas the infrared light is irregularly reflected by the defect on the film F such as the scratch, dust and the like to decrease the energy distribution intensity of the infrared light in the portion thereof thereby holding the image of the defect such as the scratch, dust and the like.

It should be noted that, in the present invention, the infrared light is not necessarily obtained by the infrared filter but a light source issuing infrared light such as a halogen light source may separately be provided. Further, it is preferable that the infrared light has a spectral wavelength of 750 nm or more in order to avoid an overlap with the R image.

It should also be noted that the present invention is not particularly limited to the infrared light, but a radiation having a specified wavelength which has a low absorption of the picture on the film F may be permissible.

As described above, the output signal (image data) from the scanner 12 is outputted to the image processing apparatus 14.

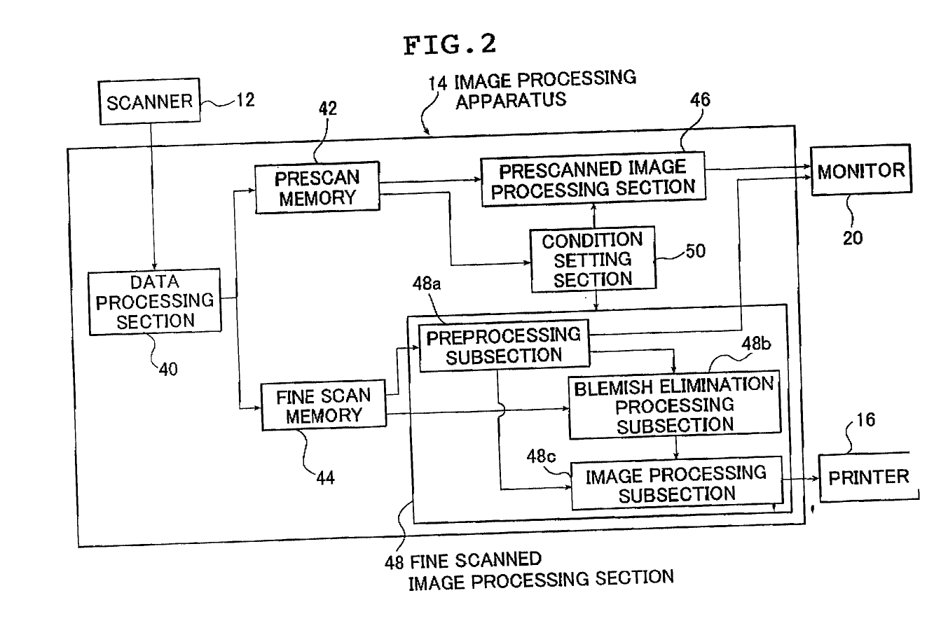

FIG. 2 is a block diagram showing an embodiment of the image processing apparatus 14. The image processing apparatus 14 comprises a data processing section 40, a prescan (frame) memory 42, a fine scan memory 44, a prescanned image processing section 46, a fine scanned image processing section 48 and a condition setting section 50.

Further, FIG. 2 mainly shows the sites related to image processing and the image processing apparatus 14 actually includes other necessary sites such as a CPU with which the photoprinter 10 as a whole including the image processing apparatus 14 is controlled and managed, a memory for storing information necessary for operation and otherwise of the photoprinter 10, a device and the like for determining a stop-down value of the variable diaphragm 24 or storage time of the CCD sensor 34 at the time of fine scan. Further, the manipulating unit 18 and the monitor for verification (image display apparatus) 20 are connected to related sites via the CPU and other necessary sites (CPU bus).

In the data processing section 40, each of the outputted signals R, G and B from the scanner 12 is subjected to logarithmic conversion, DC offset correction, dark correction, shading correction and other processing steps so that each outputted signal is converted to digital input image data in which prescanned (image) data and fine scanned data are stored in the prescan memory 42 and the fine scan memory 44, respectively.

The prescan memory 42 and the fine scan memory 44 are memory sections each for storing input image data which has been processed by the data processing section 40, and the input image data is optionally read in either the prescanned image processing section 46 or the fine scanned image processing section 48 for being subjected to image processing and then outputted.

The prescanned image processing section 46 subjects the thus read input image data to image processing such as color balance adjustment, contrast correction and brightness correction and, optionally, to transverse chromatic aberration correction, distortion aberration correction or color shift correction of the scanner and, further, to electronic magnification and, furthermore, optionally, to sharpness processing, dodging processing or the like whereby image data corresponding to display on the monitor 20 is produced and then displayed on the monitor 20.

The fine scanned image processing section 48 comprises a preprocessing subsection 48a, a blemish elimination processing subsection 48b and an image processing subsection 48c.

The preprocessing subsection 48a and the blemish elimination processing subsection 48b are sites characteristic to the present invention and are described in detail later.

The image processing subsection 48c subjects the actual image data obtained by the fine scan to color balance adjustment, contrast correction (gradation processing) and brightness correction by means of processing by an LUT (look-up table) and, further, to saturation correction and, still further, optionally, to transverse chromatic aberration correction, distortion aberration correction or color shift correction and, furthermore, to electronic magnification and, still furthermore, optionally, to sharpness processing, dodging processing or the like under an image processing condition determined based on the prescanned image data. Then, the resultant image data which has been subjected to the above image processing is further subjected to other image processing to produce image data appropriate for being outputted as the print by the printer 16 and, subsequently, the thus produced image data is sent to the printer 16.

The condition setting section 50 reads the prescanned image data from the prescan memory 42 and uses the thus read image data for determining an image processing condition. Specifically, the condition setting section 50 constructs a density histogram, calculates an image characteristic quantity such as average density, LATD (large area transmission density), highlight (minimum density), shadow (maximum density) and the like and, further, in response to commands optionally entered by an operator, determines the image processing condition such as creation of a table (LUT) for gray balance adjustment and the like, a matrix operation for saturation correction and the like, based on the prescanned data. The thus determined image processing condition is further adjusted by the operator to newly set the thus adjusted image processing condition. The thus newly set processing condition is also applied to the actual image data by the fine scan in the fine scanned image processing 48.

Now, the preprocessing subsection 48a is a site which is characteristic to the present invention and is arranged such that, while the preprocessing which is performed before the blemish elimination processing is an individual step separated from the blemish elimination processing subsection 48b and the preprocessing is performed during the time or before the image on the film is fine scanned by a visible light. The defective image read by the infrared light, in which a blur is likely to be generated in the image read by a lens of the imaging lens unit 32, is subjected to edge enhancement processing so as to enhance an edge of a defective portion, emphasize a boundary thereof and then define the position of the defect.

Since the preprocessing which is performed before the blemish elimination processing is arranged such that it is performed during the time or before the image on the film F is fine scanned by a visible light, the time consumed only for the preprocessing is shortened or lost whereby the processing time in the fine scanned image processing section 48 is shortened.

The preprocessing subsection 48a evaluates whether image data which is smaller than a given threshold value is present or not before the preprocessing by the edge enhancement is performed and then, being based on the threshold value, automatically judges or evaluates whether the blemish is present or not. Further, the defective image is displayed on the monitor 20 and then the operator may judge or evaluate the presence or absence of the blemish while looking at the thus displayed defective image. When it is judged that the blemish is absent or that a degree of the blemish is not so large as that which necessitates the blemish elimination processing, the defective image is direct sent to the image processing subsection 48c, without being subjected to the preprocessing to be performed in the preprocessing subsection 48a or the blemish elimination processing to be performed in the blemish elimination processing subsection 48b. By taking the above arrangement, processing time used for the preprocessing or the blemish elimination processing is shortened to enhance processing efficiency.

It should be noted that the edge enhancing processing to be performed in the preprocessing subsection 48a is not limited to any particular way but any known sharpness enhancing processing such as Gaussian USM (unsharp mask), Laplacian filtering and the like may be permissible.

For example, in the Gaussian USM, based on the image data I(x, y) of the defective image (wherein x, y are coordinates representing the position of a pixel of interest in the image), image data of pixels within a mask having a certain area around the pixel of interest x, y are multiplied by weighting factors in a form of normal distribution and averaged to obtain a smoothed image data <I (x, y)> which is subtracted from the Image data I(x, y) of the defective image to give an edge enhanced component I(x,y)−<(x, y)> which is subsequently multiplied by a factor “a” which is a constant for adjusting the degree of sharpness enhancement and added to the image data I(x,y) to yield edge enhanced image data.

On the other band, the Laplacian filtering is a method of enhancing the sharpness by subtracting a second partial derivative (Laplacian) ∇²I(x, y) of the image data I(x, y) from the image data. It is possible to obtain the edge enhanced image data by calculating the above method.

Further, the thus obtained edge enhanced image data of the defective portion is binary coded with 0 or 1 by a predetermined threshold value, or a threshold value set by the command entered by the operator whereby the defective portion can easily be distinguished by 0 or 1 at the time of the blemish elimination processing. On this occasion, the pixel position of the defective portion may be extracted from the binary coded image data as a numeric value and subsequently stored in a table or the like provided in the blemish elimination processing subsection 48b.

Moreover, flag information which imparts information of the presence or absence of the defect on a pixel unit basis may be produced from the defective image and subsequently added to the image data of the actual image. The actual image data is in 10 bits. When it is added with the image data of R, G and B images, it come to be 30 bits altogether. Since the CPU bus which performs image processing is in 32 bits, the difference between the above two becomes 2 bits, namely, the value of 0 to 3, with which the defective information such as the presence or absence of the blemish, the degree of the blemish and the like, as well as the actual image data can be handled at the time of blemish elimination processing.

It should be noted that, in the present embodiment, the edge enhancement processing is performed as an example of preprocessing; however, the present invention is not limited to the above-described way and any preprocessing is permissible as long as it specifies the position or degree of the defective portion in the defective image.

The blemish elimination processing subsection 48b is a site which performs the blemish elimination processing on the image data of the actual image read by the fine scan, based on the information of the image data of the defective image which has been preprocessed by the preprocessing subsection 48a and is arranged such that the image data of the actual image is sent to the blemish elimination processing subsection 48b via the fine scan memory 44. The thus sent image data of the actual image is subjected to the blemish elimination processing. The blemish elimination processing can easily detect the position and boundary of the blemish, based on the binary coded defective image which has been preprocessed by the preprocessing subsection 48a, so that the blemish elimination processing can be performed in a short period of time. It should be noted that the blemish elimination processing is performed by a known method as described above but is not particularly limited thereto.

When the blemish is shallow so that the blemish can be repaired by using image data of R, G and B of the actual image and if, for example, the image data at the pixel position of the blemish of the detective image is larger than the predetermined value, that is, when the intensity of infrared light has not been decreased to a lower value than the predetermined one, the blemish elimination processing is performed by making the R, G and B values of the actual image data larger in a uniform manner. The reason why the R, C and B values of the actual image data are uniformly made larger is that the scratch or dust on the film P is not absorbed colorwise in a specified wavelength unlike the picture and absorption characteristics are flat over all ranges of wavelengths of the visible light. On the other hand, when the scratch is deep so that the blemish can not be repaired by the image data of R, G and B of the actual image and if, for example, the image data at the pixel position of the blemish of the defective image is smaller than the predetermined value, that is, when the intensity of infrared light has been decreased to a lower value than the predetermined one, the above-described blemish elimination processing is not performed by using the image data of the blemish portion but is performed by using image data which has been produced by interpolating image data therearound.

Further, when the preprocessing to be performed by the preprocessing subsection 48a is executed at the time of reading the actual image by the fine scan at the latest.

On this occasion, when the preprocessing subsection 48a extracts the pixel position of the defective portion from the binary coded image data as a numeral to store it in a table of the blemish elimination processing subsection 48b, it is preferably arranged that the pixel position of the blemish is stored in the table of the blemish elimination processing subsection 48b by the time the image data of the actual image data obtained by the fine scan of the scanner 12 is sent to the blemish elimination processing subsection 48b (completion of obtaining the actual image). In doing so, at the time of the blemish elimination processing of the actual image, the pixel position of the blemish can rapidly be read to perform the above-described blemish elimination processing on the actual image.

Further, when the flag information which imparts the information of the presence or absence of the defect on a pixel unit basis is produced from the defective image, it is preferably arranged that the flag information is produced by the time the image data of the actual image obtained by the fine scan is sent to the blemish elimination processing subsection 48b (completion of obtaining the actual image). It is because that, when the above-described blemish elimination processing is performed, the blemish information can be obtained with reference to the flag information and subsequently, being based on the thus obtained information, the above-described blemish elimination processing can rapidly be performed.

The printer 16 comprises a recording apparatus (printing apparatus) which exposes the light-sensitive material (photographic paper) in accordance with the supplied image data to record the latent image thereon and a processor (developing machine) which subjects the thus exposed light-sensitive material to predetermined processing steps to produce the print. In the recording apparatus, the light-sensitive material is cut to a predetermined length in accordance with the size of the final print; thereafter, three types of light beams for exposure to R (red), G (green) and B (blue) in accordance with the spectral sensitivity characteristics of the light-sensitive material are modulated in accordance with the image data from the image processor 14; the thus modulated three types of light beams are deflected in the main scanning direction and, at the same time, the light-sensitive material is transported in the auxiliary scanning direction perpendicular to the main scanning direction to expose the light-sensitive material by two-dimensional scanning with the above-described light beams thereby recording the latent image thereon; the light-sensitive material having the latent image recorded thereon is supplied to the processor which subsequently performs a wet development process comprising color development, bleach-fixing, rinsing and the like; the thus processed light-sensitive material is dried to produce a finished print; plural sheets of the thus produced print are sorted in a predetermined unit, for example, for each film roll.

Further, FIG. 2 mainly shows the sites related to image processing and the image processing apparatus 14 actually includes other necessary sites such as a CPU with which the photoprinter 10 as a whole including the image processing apparatus 14 is controlled and managed, a memory for storing information necessary for operation and otherwise of the photoprinter 10, a device and the like for determining a stop-down value of the variable diaphragm 24 or storage time of the CCD sensor 34 at the time of fine scan.

Next, the image processing method according to the present invention is described based on the digital photoprinter 10.

First of all, the prescan is performed by the scanner 12, in which the visible light issuing from the light source 22 is adjusted of its light quantity by the variable diaphragm 24, adjusted bypassing through R, G and B color filters of the filter plate 26, diffused by the diffusion box 28, incident on the film F and transmitted therethrough to produce projected light carrying the image recorded on the film F in the frame of interest. The projected light of the film F is focused through the imaging lens unit 32 on a light receiving plane of the CCD sensor 34 and is photoelectrically read by the CCD sensor 34 to produce an image signal whereby the thus produced image signal is amplified by the amplifier 36, subjected to the A/D conversion by the A/D converter 38 and sent to the image processing apparatus 14. The above-described processing is performed in relation to three color filters of R (red), G (green) and B (blue) of the filter plate 26 and is not performed in relation to the infrared filter.

The prescanned image data stored in the prescan memory 42 is read into the condition setting section 50 where construction of density histogram, calculation of image characteristic quantities such as average density, LATD (large-area transmission density), highlight (minimum density), shadow (maximum density) and the like are performed and, in addition thereto, in response to an optionally-executed command entered by the operator, an image processing condition such as construction of a table (LUT) fox gray balance adjustment and the like or a matrix operation (MTX) for performing saturation correction is determined. The thus determined condition is further adjusted by a key adjustment; the thus adjusted image processing condition is reset; all these conditions are coordinated and sent to the prescanned image processing section 46.

In the prescanned image processing section 46, image processing steps of color balance adjustment, contrast correction and brightness correction are performed and, optionally, transverse chromatic aberration correction, distortion aberration correction or correction of color shift of the scanner is performed and, further, electronic magnification processing is performed and, further optionally, sharpness processing, dodging processing or the like is performed to produce image data corresponding to the monitor 20 which is subsequently displayed on the monitor 20.

Such prescan is performed on all images recorded on the film F in frames, before the fine scan is performed.

Looking at the processed image of the prescanned image displayed on the monitor 20, the operator performs verification and confirmation, and then the fine scan is performed by the scanner 12.

The fine scan starts at obtaining image data of the defective image by the infrared light via infrared filter of the filter plate 26. That is, the infrared light issuing from the light source 22 is quantitywise adjusted by the variable diaphragm 24, adjusted by passing through the infrared filter of the filter plate 26, diffused by the diffusion box 28, incident on the film F and thereafter passes therethrough to produce projected light bearing the image of the scratch, dust fingerprint or dirt on the image recorded on the film F in the frame of interest.

The projected light of the film F is focused on the light-receiving plate of the CCD sensor 34 by the imaging lens unit 32, photoelectrically read by the CCD sensor 34 to produce an output signal which is subsequently amplified by the amplifier 36 and sent to the image processing apparatus 14.

The thus obtained image data of the defective image is sent to the preprocessing subsection 48a via fine scan memory 44. In the preprocessing subsection 48a, before the preprocessing by means of the edge enhancement is performed, the presence or absence of the image data which is smaller than a given threshold value is judged whereby the presence or absence of the blemish is automatically evaluated. When it is judged that the blemish is absent or the degree thereof is not so large as to require the blemish elimination processing, the image data is not subjected to the preprocessing by the preprocessing subsection 48a or to the blemish elimination processing by the blemish elimination processing subsection 48b and is direct sent to the image processing subsection 48c. By this step, processing time for preprocessing or the blemish elimination processing is shortened and the processing efficiency is enhanced. Further, instead of automatically judging the presence or absence of the blemish, the defective image is displayed on the monitor 20 and, looking at the thus displayed image, the operator may judge the presence or absence of the blemish.

When the blemish elimination processing is performed, the edge enhancement of the defective image is performed in the preprocessing subsection 48a in the way as described above and the like; the position and boundary of the blemish are clearly defined and the image data of the defective image is binary-coded by a value of 0 or 1 based on a preset threshold or a threshold set by a command entered by the operator. In doing the above step, it becomes possible to easily discriminate a defective portion at the time of the blemish elimination processing. Further, the pixel position of the defective portion is digitalized from the binary-coded image data and the thus digitalized value may be recorded in a table or the like provided in the blemish elimination processing subsection 48b and, further, the flag information which imparts the information of the presence or absence of the defect on a pixel unit basis may be produced from the defective image and added to the image data. In either one of the above-described ways, the defective portion can easily be discriminated at the time of the blemish elimination processing so that the blemish elimination processing can be performed in a short period of time.

On the other hand, while the preprocessing such as the edge enhancement processing as described above and the like is being performed, the actual image of the image on the film F is fine scanned in the scanner 12 by using three color filters of R, G and B and is photoelectrically read by the CCD sensor 34 to produce the output signals which are subsequently amplified by the amplifier 36 and sent to the image processing apparatus 14. Particularly, it is preferable from the standpoint of further improving the processing efficiency of the blemish elimination processing that the preprocessing including the edge enhancement in the first place is finished by the time of completion of obtaining the actual image by the fine scan, that is, before the image data of the actual image is sent to the blemish elimination processing subsection 48b. To attain this preference, the preprocessing starts while the fine scan is being performed at the latest. The preprocessing may start even before the fine scan starts.

The thus obtained image data of the actual image is stored in the main scan memory 44 and simultaneously sent to the blemish elimination processing subsection 48b. Further, the binary-coded defective image subjected to the preprocessing by the preprocessing subsection 48a at the time of the fine scan of the actual image is also sent to the blemish elimination processing subsection 48b; the blemish elimination processing of the actual image is performed by using the above-described defective image in binary code.

Since the preprocessing which requires relatively long period of time is performed during the time of reading the actual image by the fine scan at the latest in the way as described above, processing steps can be performed in a shorter period of time compared with the ordinary case in which the preprocessing and the blemish elimination processing are performed after the actual image and the defective image are read.

When the blemish is shallow and can be repaired by using the image data of R, G and B of the actual image, for example, when the image data at the pixel position of the blemish of the defective image is larger than the predetermined value, that is, when the intensity of the infrared light has not been decreased to a level lower than the predetermined value, the blemish elimination processing is performed by uniformly enlarging the R, G and B values of the actual image data at the pixel position of the blemish On the other hand, when the blemish is deep and can not be repaired only by using the image data of R, G and B of the actual image, for example, when the image data at the pixel position of the blemish of the defective image is smaller than the predetermined value, that is, when the intensity of the infrared light is lower than the predetermined value, the blemish elimination processing is performed by a known interpolation method. It should be noted that the blemish elimination processing is not limited to the above-described ways but may be performed by a known method.

The image which has been subjected to the blemish elimination processing is subsequently subjected to various types of image processing by a table (LUT) for gray balance adjustment and the like or a matrix operation (MTX) for saturation correction, based on the image processing condition of the prescanned image which has been adjusted and determined by the operator and, further, is optionally subjected to the correction of transverse chromatic aberration, correction of distortion aberration or color shift correction and, furthermore, is subjected to electronic magnification processing. Thereafter, the resultant image data is processed to be output data for a print output image which is then sent to the printer 16.

In the recording apparatus of the printer 16, the light-sensitive material is cut in a predetermined length in accordance with a size of a print; thereafter, three light beams for R, G and B exposures in accordance with the spectral sensitivity characteristics of the light-sensitive material are modulated in accordance with the image data outputted from the image processing apparatus 14; the thus modulated three light beams are deflected in the main scanning direction while, simultaneously, the light-sensitive material is transported in the auxiliary scanning direction perpendicular to the main scanning direction so as to record the latent image by two-dimensional scan exposure with the above-described light beams. The light-sensitive material bearing the thus recorded latent image is then supplied to the processor. Receiving the light-sensitive material, the processor performs a predetermined wet development process comprising color development, bleach-fixing, rinsing and the like; the thus processed light-sensitive material is dried to produce the print; a plurality of sheets of the thus produced print are sorted and stacked in specified units, say, one roll of film; hence, prints can be obtained in the way as described above.

Further, in the above-described embodiment, the prescan for preliminarily setting the image processing condition and the fine scan for outputting the print are provided, and the image processing apparatus is of a type which performs the image data processing divided into two series by the prescan and fine scan; however, the image processing apparatus may be of another type which determines the image processing condition by thinning some data from the fine scanned image data without performing the prescan.

Further, in the embodiment, the scanner 12 uses the CCD sensor 34 as an area sensor and captures the defective image (IR image) and the actual image (R image, G image, B image) by an areal exposure on a plane of the CCD sensor 34. The scanner 12 is not limited to this type but may be of a type by slit scanning in which an IR line CCD sensor and an RGB 3-line CCD sensor that are aligned in a direction perpendicular to the lengthwise direction of the film F are used to restrict the projected light through the film F in a predetermined slit form thereby reading the defective image (IR image) with the IR line CCD sensor and the actual image (R image, G image, B image) with the RGB 3-line CCD sensor.

In the above case, in order to enhance the efficiency and the speed in the whole image processing which includes reading images on a film for obtaining output images, the defective image (IR image) is first read, after which the preprocessing of the defective image is performed while or before the actual image is read (by fine scan). This is not however the sole case of the present invention. When the whole processing requires little time or the actual image was read separately, reading of the defective image may be followed by the preprocessing thereof, irrespective of reading of the actual image.

In the above case, a color image is read as the actual image for RGB three colors and then subjected to the blemish elimination processing for each color. However, the present invention is not limited to this case and the actual image to be read may be a monochromic image or a black-and-white image.

While the image processing method of the present invention has been described above in detail, it should be noted that the invention is by no means limited to the foregoing embodiments and various improvements and modifications may of course be made without departing from the scope and spirit of the invention.

As described above in detail, according to the present invention, since the defective image is read as information related to the defect on the film and the preprocessing of the blemish elimination processing is performed on this defective image while the actual image can simultaneously be obtained by photoelectrically reading the image, the blemish elimination processing can efficiently be performed on the blemish on the actual image in a short period of time by using the defective image having information related to the defect, for example, caused by the scratch, dust or the like, on the film in the frame to be read. In particular, when the preprocessing is performed while or before the actual image is read, the whole image processing for obtaining the output image including reading of the image and the blemish elimination processing can be efficiently performed in a short period of time. Therefore, processing efficiency and hence productivity at the time of processing images in volume are enhanced.

Particularly, the processing efficiency is more enhanced by performing the preprocessing by the time of completion of obtaining the actual image.

Further, the defective image is evaluated and the preprocessing and the blemish elimination processing can be omitted in accordance with a thus evaluated result so that the processing efficiency is even more enhanced.

What is claimed is:

1. An image processing method for photoelectrically reading an image on a film and then performing a blemish elimination processing, comprising the steps of:
reading a defective image as information related to a defect on the film;
then, reading photoelectrically said image to obtain an actual image;
performing preprocessing for the blemish elimination processing on said defective image while reading photoelectrically said image; and
performing the blemish elimination processing on a blemish of said actual image, based on the defective image subjected to said preprocessing.

2. The image processing method according to claim 1, wherein said preprocessing is finished up to completion of obtaining said actual image.

3. The image processing method according to claim 1,
wherein the image on the film is sequentially read on a plane basis, and
wherein said actual image is obtained and the blemish elimination processing is performed on the actual image by using said defective image subjected to said preprocessing.

4. The image processing method according to claim 1,
wherein said defective image is evaluated to obtain a evaluated result, and
wherein said preprocessing and said blemish elimination processing are stopped in accordance with said evaluated result.

5. The image processing method according to claim 1, wherein said preprocessing is edge enhancement processing of the defective image or production of flag information which imparts presence or absence of the defect on a pixel unit basis from the defective image.

6. The image processing method according to claim 1, wherein said defective image is photoelectrically read by using infrared light.

7. An image processing method for photoelectrically reading an image on a film and then performing a blemish elimination processing, comprising the steps of:
reading a defective image as information related to a defect on the film;
performing preprocessing for the blemish elimination processing on said defective image; and
performing the blemish elimination processing on a blemish of an actual image which is obtained by reading photoelectrically said image, based on the defective image subjected to said preprocessing.

8. The image processing method according to claim 7, wherein said preprocessing is edge enhancement processing of the defective image or production of flag information which imparts presence or absence of the defect on a pixel unit basis from the defective image.

9. The image processing method according to claim 7, wherein said defective image is photoelectrically read by using infrared light.

10. The image processing method according to claim 7,
wherein said defective image is evaluated to obtain a evaluated result, and
wherein said preprocessing and said blemish elimination processing are stopped in accordance with said evaluated result.

11. The image processing method according to claim 7, wherein said preprocessing is finished up to completion of obtaining said actual image.
